(19) United States
(12) Patent Application Publication
(10) Pub. No.: US 2010/0066516 A1
(43) Pub. Date: Mar. 18, 2010

(54) IMAGE DISPLAYING IN-VEHICLE SYSTEM, IMAGE DISPLAYING CONTROL IN-VEHICLE APPARATUS AND COMPUTER READABLE MEDIUM COMPRISING PROGRAM FOR THE SAME

(75) Inventor: Norifumi MATSUKAWA, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/558,912

(22) Filed: Sep. 14, 2009

(30) Foreign Application Priority Data
Sep. 15, 2008 (JP) 2008-235805

(51) Int. Cl. B60Q 1/00

(52) U.S. Cl. 340/435

(57) ABSTRACT

An image displaying control in-vehicle apparatus is disclosed. The apparatus is configured to acquire obstacle information from the sensor for detecting an obstacle existing around the vehicle. The apparatus is further configured to cause a display device to display a first display image showing a first region of an outside of the vehicle based on a camera image captured by a camera when the sensor does not detect an obstacle existing around a vehicle. When the sensor detects an obstacle existing at a first direction away form the first region the apparatus is configured to cause the display device to display a second display image showing a second region covering a place that is away from the first region in the first direction.

### CROSS REFERENCE TO RELATED APPLICATION

The present application is based on Japanese Patent Application No. 2008-235805 filed on Sep. 15, 2008, disclosure of which is incorporated herein by reference.

### BACKGROUND OF THE INVENTION

1. Field of the Invention

The present invention relates to an image displaying in-vehicle system including a camera mounted to a vehicle to capture an image of an outside of the vehicle and a display device for displaying the captured image. The present invention further relates to an image displaying control in-vehicle apparatus for performing control in the image displaying in-vehicle system. The present invention further relates to a computer readable medium comprising a program for the image displaying control in-vehicle apparatus.

2. Description of Related Art

There is widely used an image displaying in-vehicle system, which includes a camera mounted to a vehicle to capture an image of an outside of the vehicle and a display device for displaying the captured image in a vehicle compartment.

According to a conventional image displaying in-vehicle system, in some cases, a driver of the vehicle cannot notice an obstacle when the obstacle is located outside a region that the display device displays as the image. For example, when an obstacle is located around a left or right corner part of a rear of the vehicle, the image displaying in-vehicle system cannot display an image of the obstacle to a driver.

To address the above described difficulty, the inventor of the present application has reviewed the following method. A vehicle is equipped with a wide angle camera, which is capable of capturing a wide angle image of a region with, for example, a horizontal angle of view of 180 degrees. The display device normally displays an image of a part of a maximum photographing range, which the wide angle camera can capture as the wide angle image. For example, the display device normally displays an image of a region corresponding to a horizontal angle of view of 120 degrees. When required, the display device displays the maximum photographing range of the camera.

When the above described method is used, it becomes possible for the display device to display an additional region, which is not displayed normally. When display device displays the additional region, however, since the displayed image corresponds to the maximum photographing range of the camera, a size of the additional region becomes relatively small on a screen of the display device. In spite of display of the additional region, a vehicle occupant is difficult to read information from the display of the additional region, since the size of the display of the additional region is small on the screen.

### SUMMARY OF THE INVENTION

In view of the above and other points, it is an objective of the present disclosure to provide an image displaying in-vehicle system and an image displaying control in-vehicle apparatus that are capable of displaying a display target range to a vehicle occupant in an easily-viewable manner. It is an also objective of the present disclosure to provide a computer readable medium comprising a program for an image displaying control in-vehicle apparatus.

According to a first aspect of the present disclosure, there is provided an image displaying control in-vehicle apparatus for a vehicle equipped with (i) a sensor for detecting an obstacle existing around the vehicle, (ii) a camera for capturing a camera image of an outside of the vehicle, and (iii) a display device. The image displaying control in-vehicle apparatus includes an acquisition section and a display control section. The acquisition section acquires obstacle information from the sensor. The obstacle information includes information on whether the sensor detects a presence of the obstacle. The obstacle information further includes information on a location of the obstacle when the sensor detects the presence of the obstacle. The display control section causes the display device to display a first display image showing a first region of the outside of the vehicle based on the camera image when the obstacle information indicates that the sensor detects an absence of the obstacle. The first region covers a center of a photographing range of the camera. The display control section further causes the display device to display a second display image showing a second region of the outside of the vehicle based on the camera image when the obstacle information indicates that the sensor detects the presence of the obstacle and when the obstacle information further indicates that the location of the obstacle is away from the first region in a first direction. The second region is a part of the photographing range of the camera and covers a place that is away from the first region in the first direction.

According to a second aspect of the present disclosure, there is provided an image displaying in-vehicle system for a vehicle equipped with a sensor for detecting an obstacle existing around the vehicle. The image displaying in-vehicle system includes: a camera mounted to a vehicle and configured to capture a camera image of an outside of the vehicle; a display device; and an image displaying control in-vehicle apparatus coupled with the camera and the display device. The image displaying control in-vehicle apparatus includes an acquisition section and a display control section. The acquisition section is configured to acquire obstacle information from the sensor. The obstacle information includes information on whether the sensor detects a presence of the obstacle. The obstacle information further includes information on a location of the obstacle when the sensor detects the presence of the obstacle. The display control section is configured to cause the display device to display a first display image showing a first region of the outside of the vehicle based on the camera image when the obstacle information indicates that the sensor detects an absence of the obstacle. The first region covers a center of a photographing range of the camera. The display control section is further configured to cause the display device to display a second display image showing a second region of the outside of the vehicle based on the camera image when the obstacle information indicates that the sensor detects the presence of the obstacle and when the obstacle information further indicates that the location of the obstacle is away from the first region in a first direction. The second region is a part of the photographing range of the camera and covers a place that is away from the first region in the first direction.

According to a third aspect of the present disclosure, there is provided a computer readable medium comprising instructions to causes an image displaying control in-vehicle apparatus, which is for use in a vehicle equipped with (i) a sensor for detecting an obstacle existing around the vehicle, (ii) a camera for capturing a camera image of an outside of the vehicle, and (iii) a display device, to execute steps of: acquiring obstacle information from the sensor, the obstacle information including information on whether the sensor detects a presence of the obstacle, the obstacle information further including information on a location of the obstacle when the sensor detects the presence of the obstacle; and causing the display device to display a first display image showing a first region of the outside of the vehicle based on the camera image when the obstacle information indicates that the sensor detects an absence of the obstacle, the first region covering a center of a photographing range of the camera; and causing the display device to display a second display image showing a second region of the outside of the vehicle based on the camera image when the obstacle information indicates that the sensor detects the presence of the obstacle and when the obstacle information further indicates that the location of the obstacle is away from the first region in a first direction, the second region being a part of the photographing range of the camera, the second region covering a place that is away from the first region in the first direction.

According to the above image displaying control in-vehicle apparatus, the image displaying in-vehicle system or the computer readable medium, the display device can display the first display image showing the first region when the sensor detects the absence of an obstacle. When the sensor detects the presence of an obstacle, the display device displays the second image showing the second region, which is the part of the photographing range of the camera and covers the place where the presence of the obstacle is indicated. Since the second display image corresponds to the part of the photographing range of the camera, it is possible to avoid downsizing a display image part that represents a region to be notified to a vehicle occupant. In other words, it is possible to provide a vehicle occupant with an image of the region to be notified, in an easily-viewable manner.

### BRIEF DESCRIPTION OF THE DRAWINGS

The above and other objects, features and advantages of the present invention will become more apparent from the following detailed description made with reference to the accompanying drawings. In the drawings:

FIG. 1 is a diagram illustrating an image displaying in-vehicle system mounted to a vehicle according to one embodiment;

FIG. 2 is a diagram illustrating a camera image captured by a camera;

FIG. 3 is a flowchart illustrating a procedure to be performed by a sonar ECU;

FIG. 4 is a diagram illustrating a relationship between detection results of an obstacle sensor and display modes;

FIG. 5 is a flowchart illustrating a procedure to be performed by a camera ECU;

FIG. 6 is a diagram illustrating a display target range in a first display mode;

FIG. 7 is a diagram illustrating a first display part that is to be extracted from a camera image in the first display mode;

FIG. 8 is a diagram illustrating a second display part that is to be extracted from a camera image in the first display mode;

FIG. 9 is a diagram illustrating a display target range in a second display mode;

FIG. 10 is a diagram illustrating a display target range in a third display mode;

FIG. 11 is a diagram illustrating a first display part that is to be extracted from a camera image in the third display mode;

FIG. 12 is a diagram illustrating a second display part that is to be extracted from a camera image in the third display mode; “4”;

FIG. 13 is a diagram illustrating a display target range in a fourth display mode

FIG. 14 is a diagram illustrating a first display part that is to be extracted from a camera image in the fourth display mode;

FIG. 15 is a diagram illustrating a second display part that is to be extracted from a camera image in the fourth display mode;

FIG. 16 is a diagram illustrating a first relationship between an angle “α1” of a display target range and a distance from a vehicle to an obstacle in the fourth display mode;

FIG. 17 is a diagram illustrating a second relationship between angle “α2” of a display target range and a distance from a vehicle to an obstacle in the fourth display mode; and

FIG. 18 is a diagram illustrating a third relationship between angle “α3” of a display target range and a distance from a vehicle to an obstacle in the fourth display mode.

### DETAILED DESCRIPTION OF THE EXEMPLARY EMBODIMENTS

The exemplary embodiments are described below with reference to the accompanying drawings.

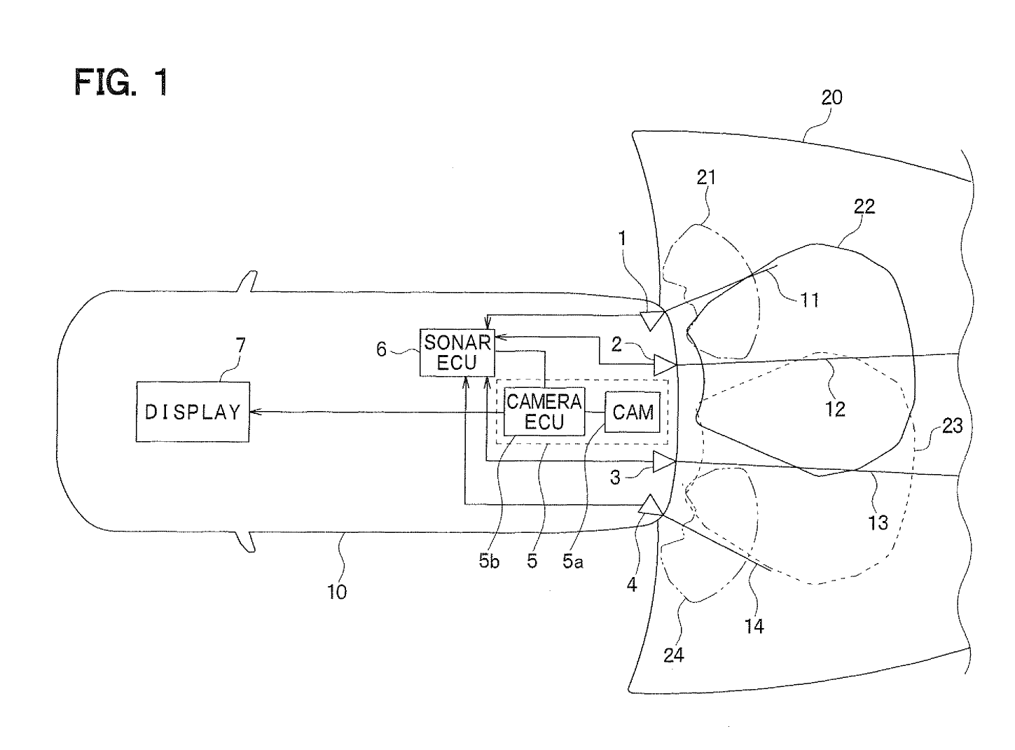

FIG. 1 illustrates an image displaying in-vehicle system mounted to a vehicle 10 in accordance with one embodiment. The image displaying in-vehicle system includes multiple obstacle sensors 1 to 4, a rearward imaging unit 5, a sonar ECU (Electronic Control Unit) 6, and a display device 7. The sonar ECU 6 acts as an example of an image displaying control in-vehicle apparatus.

Each obstacle sensor 1 to 4 is, for example, a sonar, which transmits a sound wave, detects the sound wave reflected from an obstacle, obtains a difference between a time of transmitting the sound wave and a time of detecting the reflected sound wave, and thereby cyclically specifies a distance between the obstacle sensor and the obstacle at, for example, 0.1 second cycles. The obstacle sensor 1 to 4 outputs a detection signal, which indicates the presence or absence of an obstacle and the distance to obstacle, to the sonar ECU 6. The obstacle sensors 1 to 4 are mounted to different positions of the vehicle 10 so as to have different obstacle detection ranges.

More specifically, the right end obstacle sensor 1 is mounted to a right end part of a rear of the vehicle 10, so that the obstacle sensor 1 can detect the presence of an obstacle in a detection range 21, which covers a region around the right end part of the rear of the vehicle 10. The obstacle sensor 1 also can detect a distance to the obstacle, in other words, a distance from the right end part of the rear of the vehicle 10 to the obstacle.

The obstacle sensor 2 is mounted to a part between the right end part and the center of the rear of the vehicle 10, so that the obstacle sensor 2 can detect the presence of an obstacle in a detection range 22, which covers a region located rearward of the part to which the obstacle sensor 2 is mounted. The obstacle sensor 2 also can detect a distance to the obstacle, in other words, a distance from the rear of the vehicle 10 to the obstacle.

The obstacle sensor 3 is mounted to a part between a left end part and the center of the rear of the vehicle 10, so that the obstacle sensor 3 can detect the presence of an obstacle in a detection range 23, which covers a region located rearward of the part to which the obstacle sensor 3 is mounted. The obstacle sensor 3 also can detect a distance to the obstacle, in other words, a distance from the rear of the vehicle to the obstacle.

The left end obstacle sensor 4 is mounted to a left end part of the rear of the vehicle 10, so that the obstacle sensor 4 can detect the presence of an obstacle in a detection range 24, which includes a region around the left end part of the rear of the vehicle 10. The obstacle sensor 4 also can detect a distance to the obstacle, in other words, a distance from the left end part of the rear of the vehicle 10 to the obstacle.

The positions where the obstacle sensors 1 to 4 are respectively mounted are arranged in a row from the right end part to the left end part of the rear of the vehicle 10 in the order of the right end obstacle sensor 1, the obstacle sensor 2, the obstacle sensor 3 and the left end obstacle sensor 4. The detection ranges 21 to 24 are arranged in a row from an area located right rearward of the vehicle 10 to an area located left rearward of the vehicle 10 in the order of the detection range 21, the detection range 22, the detection range 23 and the detection range 24. The sum of the detection ranges 21 to 24 of the obstacle sensors 1 to 4 covers almost or all of the horizontal angle of view of the camera 5a, in other words, covers the maximum right-to-left angular extent of a photographing range 20 of the camera 5a, photographing range 20 corresponding a region that that the camera 5a can capture as the image. It should be noted that the detection ranges 21 and 22 partly overlap each other, the detection ranges 22 and 23 partly overlap each other, and the detection ranges 23 and 24 partly overlap each other.

As seen above, each obstacle sensor 1 to 4 can obtain and provide obstacle information including (i) information about whether an obstacle is present in its detection range and (ii) information about the distance from the obstacle sensor to the obstacle.

The detection range 21 of the right end obstacle sensor 1 covers a region around a right corner of the rear end of the vehicle, and is in shape a circular sector whose center is at the right end obstacle sensor 1 and whose radius acting as a detection limit distance is 60 cm for instance. The detection range 24 of the left end obstacle sensor 4 covers a region around a left corner of the rear end of the vehicle, and is in shape a circular sector whose center is at the left end obstacle sensor 4 and whose radius acting as a detection limit distance is 60 cm for instance.

Detection axes 11 to 14 in FIG. 1 respectively represent straight lines that pass through the centers of the detection ranges 21 to 24 and the obstacle sensors 1 to 4. The detection axes 11 to 14 also represent the centers of the detection ranges 21 to 21 in left-to-right directions, respectively.

The display device 7 is mounted in a vehicle compartment of the vehicle 10. When the display device 7 receives an image signal from the rearward imaging unit 5, the display device 7 displays a display image based on the image signal on a predetermined portion of a screen of the display device 7, so that a driver in the vehicle compartment can visually recognize the display image

The rearward imaging unit 5 includes a camera ECU 5b in addition to the camera 5a. The camera 5a is mounted to the rear of the vehicle 10. The camera 5a cyclically captures a camera image of a region rearward of the vehicle 10 with a wide angle of view at, for example, 0.1 second cycles, and outputs a signal containing the camera image to the camera ECU 5b.

The region that the camera 5a can capture as an image is, for example, the photographing range 20. More specifically, the region that is captured by the camera 5a at a single shoot contains the detection axes 11 to 14. The angle of view of the camera 5a, which is an angular extent of the photographing range 20 with respect to the camera 5a, is approximately 180 degrees, where the center of the angle of view matches a frontal direction of the camera 5a and a rear direction of the vehicle 10. The photographing range 20 may cover a rear end of the vehicle 10 at an end of the photographing range 20.

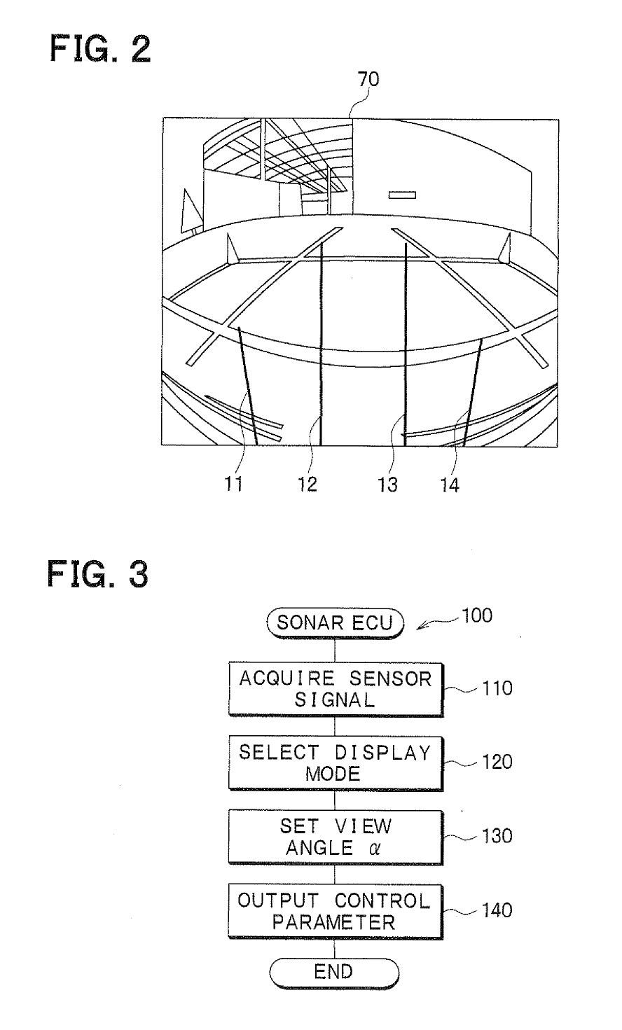

FIG. 2 illustrates one exemplary camera image 70, which is captured and outputted by the camera 5a. The camera image 70 represents the whole photographing range 20. A direction from a lower part to an upper part of the camera image 70 corresponds to a direction away from the rear end part of the vehicle 10, in other words, a direction opposite to the heading direction of the vehicle 10. A left direction and a right direction of the camera image 70 respectively correspond to a left-hand direction and a right-hand direction of a vehicle occupant who faces in the heading direction of the vehicle 10. In FIG. 2, four solid lines extending in vertical directions on the camera image 70 virtually represent the detection axes 11 to 14. Such four solid lines may or may not be actually displayed over the camera image 70.

The camera ECU 5b receives the camera image from the camera 5a. The camera ECU 5b processes the received image in some cases and does not process the received image in other cases. The camera ECU 5b causes the display device 7 to display the processed or unprocessed image as a display image. A signal from the sonar ECU 6 controls content of the processing of the camera image.

The sonar ECU 6 receives signals indicative of the location of an obstacle from the right end obstacle sensor 1 and the left end obstacle sensor 4, determines an operation content of the camera ECU 5b based on the received signals, and outputs the determined operation content to the camera ECU 5b as a display control parameter. To perform the above-described operation, the sonar ECU 6 cyclically performs a procedure 100 illustrated in FIG. 3. For example, the sonar ECU 6 cyclically performs the procedure 100 at 0.1-second cycles, as the camera 5a captures the image at 0.1-seconds cycles. The sonar ECU 6 may include a computer that reads a program comprising instructions to cause the computer to perform the procedure 100. Alternatively, the sonar ECU may include a dedicated electronic circuit for performing the procedure 100.

The procedure 100 is described below with reference to FIG. 3. At S110, the sonar ECU 6 respectively acquires the detection signals from the obstacle sensors 1 and 4, thereby acquiring information about which one or ones of the obstacle sensors 1 and 4 is detecting an obstacle, and information about a distance from the obstacle to the obstacle sensor.

At S120, the sonar ECU 6 determines a display mode to be adopted, based on the information obtained at S110. The display mode is associated with extracting a certain part from the camera image 70 captured by the camera 5a. The selectable display mode includes a first display mode “1”, a second display mode “2”, a third display mode “3” and a fourth display mode “4”. The first display mode “1” is normally used.

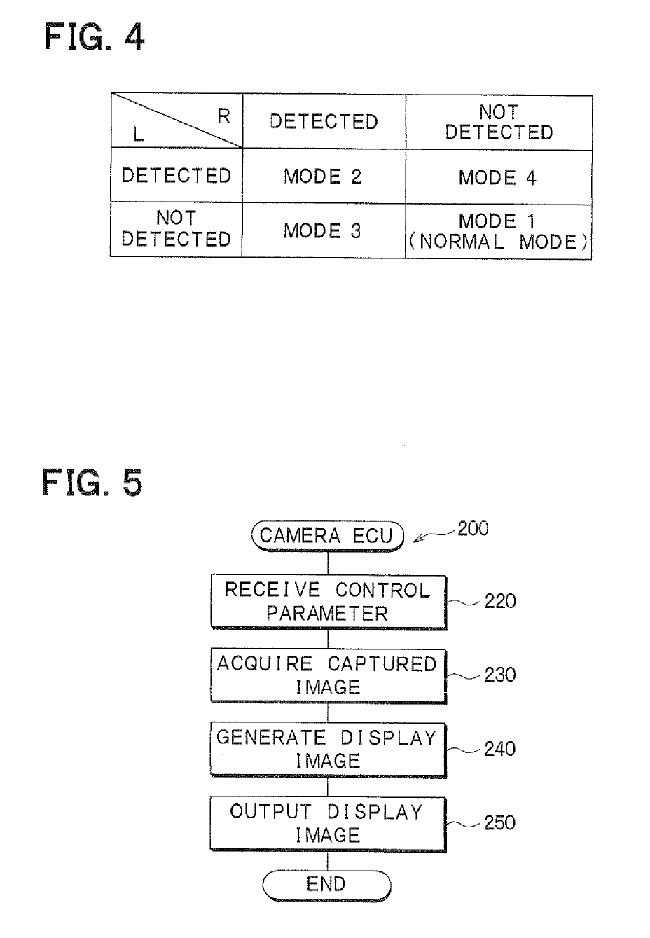

FIG. 4 illustrates relationships between information content acquired from the obstacle sensors 1, 4 and the display modes to be selected. As shown in FIG. 5, the sonar ECU 6 selects the first display mode “1” when both of the obstacle sensor 1 and the obstacle sensor 4 are not detecting an obstacle. The above case corresponds to a situation where an obstacle is not present around the right corner and the left corner of the rear of the vehicle 10. Thus, the above case covers a situation where an obstacle is not present in the whole region around the vehicle, and a situation where only the obstacle sensor 3 is detecting an obstacle.

When both of the obstacle sensors 1 and 4 are detecting obstacles, the camera ECU 5b selects the second display mode “2”. The above case corresponds to a situation where an obstacle is present in each of regions around the right corner and the left corner of the rear of the vehicle 10.

When the obstacle sensor 1 is detecting an obstacle and when the obstacle sensor 4 is not detecting an obstacle, the camera ECU 5b selects the third display mode “3”. The above case corresponds to a situation where the obstacle is present in a region around the right corner of the rear of the vehicle 10 and an obstacle is not present in a region around the left corner of the rear of the vehicle 10.

When the obstacle sensor 1 is not detecting an obstacle and when the obstacle sensor 4 is detecting an obstacle, the camera ECU 5b selects the fourth display mode “4”. The above case corresponds to a situation where an obstacle is not present in a region around the right corner of the rear of the vehicle 10 and the obstacle is present in a region around the left corner of the rear of the vehicle 10.

At 130, the sonar ECU 6 sets a cutout angle “α”. The cut angle “α” is related to the processing of the camera image 70 in the camera ECU 5b. When the first display mode “1” or the second display mode “2” is selected at S120, the cutout angle “α” is set to a predetermined dummy value, which is for example 1 degree.

When the third display mode “3” or the fourth display mode “4” is selected at S120, the cutout angle “α” is set based on a distance between the obstacle and the obstacle sensor 1 or 2 that has detected the obstacle, the distance being also refereed to as a detection distance. More specifically, the cutout angle “α” is set to a smaller value as the detection distance is longer. It should be noted that the cutout angle “α” is set so as not exceed an upper limit, which is the maximum angle of view (e.g., 180 degree) of the photographing range 20 in the left-to-right direction.

For example, the cut angle “α” may be set in the following manners. When the detection distance is in a long distance range, the cutout angle is set to 0 degree. When the detected distance is in a middle distance range, the cutout angle is set to 120 degrees. When the detected angle is in a short distance range, the cutout angle is set to 90 degrees. The long distance range may be between 40 cm and 60 cm, the meddle distance range may be between 20 cm and 40 cm, and the short distance range may be between 0 cm and 20 cm, for instance.

At S140, the sonar ECU 6 outputs the display control parameter to the camera ECU 5b. The display control parameter includes information on both of the display mode selected at S120 and the cutout angle “α” set at S130. As described later, the display control parameter is used in determining which part is extracted from the camera image and displayed on a screen of the display device 7. After S140, one cycle of the procedure 100 is ended.

The processing 200 to be performed by the camera ECU 5b is described below with reference to FIG. 5. For example, the camera ECU 5b cyclically performs the procedure 200 at, for example, 0.1-second cycles, as the camera 5a captures an image at 0.1 second cycles. The camera ECU 5b may include a computer that reads a program comprising instructions to cause the camera ECU 5b to perform the procedure 200. Alternatively, the camera ECU 5b may include a dedicated electronic circuit for performing the procedure 200.

The camera ECU 5b cyclically performs the procedure 200 when receiving an image display command. The image display command may continue to be issued and outputted to the camera ECU 5b after a user performs a predetermined display starting manipulation on an operation device (not shown). Alternatively, a gear position sensor (not shown) may issue and output the image display command to the camera ECU 5b. In the above alternative configuration, the image display command may be a signal indicating that the gear position is in a reverse position. Alternatively, the image display command may be a signal outputted from a device other than the operation device and the gear position sensor.

The procedure 200 is more specifically described below with reference to FIG. 5. At S220, the camera ECU 5b acquires a signal containing the latest display control parameter outputted from the sonar ECU 6. The display control parameter includes information about the display mode and the cutout angle “α”, as described above. At 230, the camera ECU 5b acquires the camera image, which covers the whole photographing region 20, from the camera 5a.

At S240, the camera ECU 5b may or may not process the camera image and creates a display image, based on the display control parameter acquired at S220. Contents of the processing at S240 are based on the display control parameter acquired at S220. The camera ECU 5b selects one extraction method from predetermined four extraction methods in accordance with the selected display mode indicated by the display control parameter.

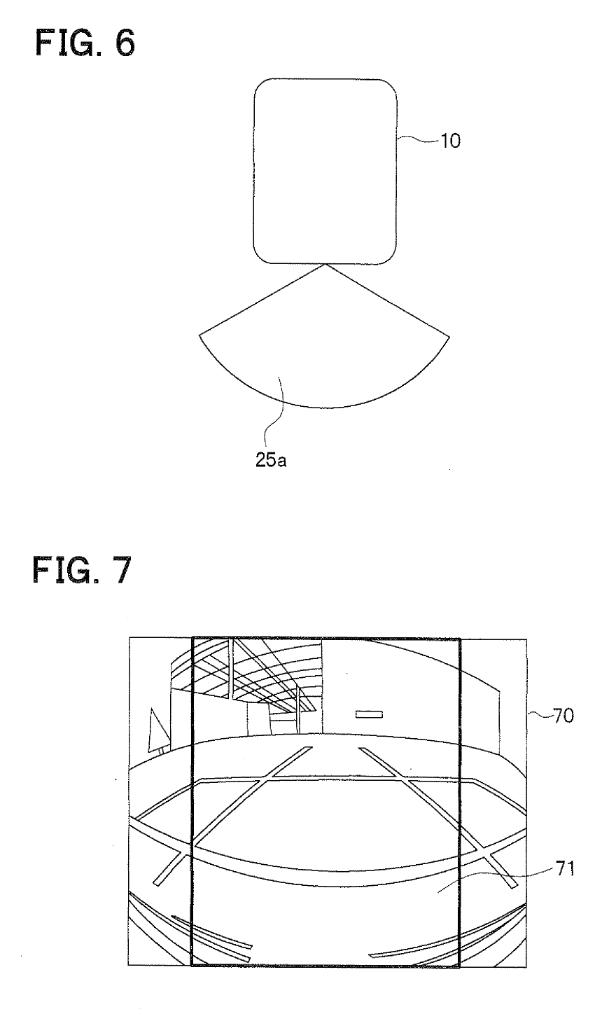

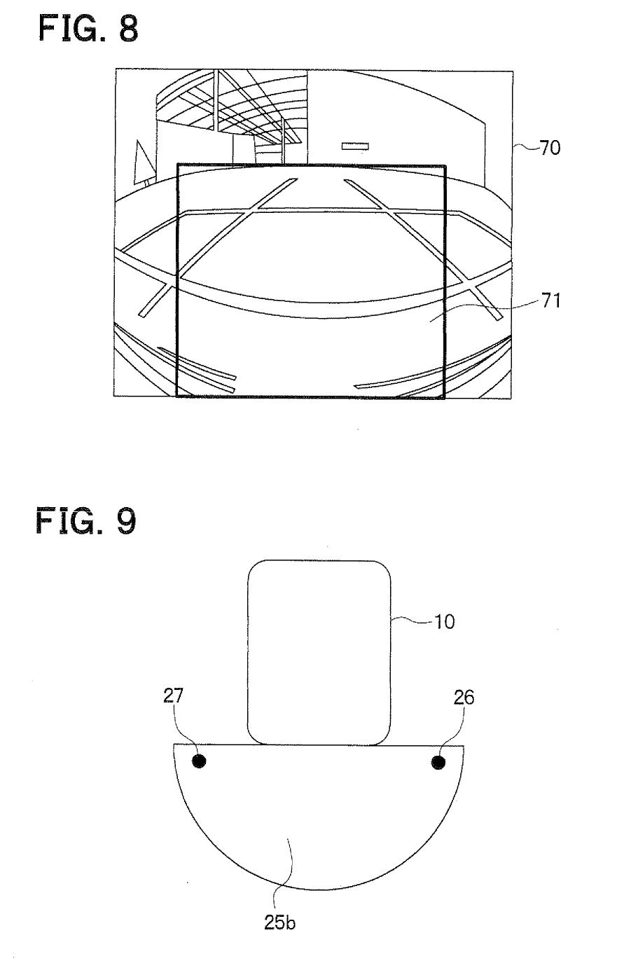

When the first display mode “1” is indicated, the camera ECU 5b uses a first extraction method. More specifically, the camera ECU 5b sets a display target range 25a as a target range for display, as shown in FIG. 6. The display target range 25a is, for example, a vehicle rearward region between two lines which extend from the center of the back of the vehicle 10 and which are respectively inclined rightward and leftward with respect to the front-rear axis of the vehicle 10 at angles of approximately 60 degrees, as shown in FIG. 6. From the camera image, the camera ECU 5a extracts a part corresponding to the display target range 25a. In a case of the camera image 70 illustrated in FIG. 2, the display target range 25a in the first mode “1” may correspond to a part 71, which is surrounded by the heavy line in FIG. 7 or FIG. 8 for instance. The display target range 25a is an example of a first region.

The part 71 illustrated in FIG. 7 is the camera image 70 whose left-side part and right-side part are cutout. A ratio of a height to a width of the display part 71 is different from that of the camera image 70. In other words, aspect ratios are different. The part 71 illustrated in FIG. 8 is the camera image 70 whose upper-side part, left-side part and the right-side part are cutout. An aspect ratio of the part 71 illustrated in FIG. 8 is substantially the same of that of the camera image 70.

When the second display mode “2” is indicated by the display control parameter, the camera ECU 5b uses a second extraction method. More specifically, the camera ECU 5b sets a display target range 25b as a target range for display. The display target range 25b is, for example, a vehicle rearward region between two lines which extend from the center of the back of the vehicle 10 and which are respectively inclined rightward and leftward with respect to the front-rear axis of the vehicle 10 at angles of approximately 90 degrees, as shown in FIG. 6. The display target range 25b corresponds to the whole photographing range 20. Therefore, the camera image captured by the camera 5a is extracted as a whole as an image corresponding to the display target range 25b.

As described above, in the second display mode “2”, each of the right end obstacle sensor 1 and the left end obstacle sensor 4 is detecting an obstacle. The detection range 21 of the right end obstacle sensor 1 covers a region that is rightward away from the display target range 25a for use in the first display mode, and the detection range 24 of the left end obstacle sensor 4 covers a region that is leftward away from the display target range 25a. Thus, there is a possibility that the location of an obstacle 26 detected by the right end obstacle sensor 1 is away from the display target range 25a in a rightward direction, and there is a possibility that the location of an obstacle 27 detected by the left end obstacle sensors 4 is away from the display target range 25a in a leftward direction. In the above, each of the leftward direction and the rightward direction corresponds to an example of the first direction.

In the above case, the adoption of the display target range 25b, which is wider than the display target range 25a in the right-left direction, increases a possibility of successfully displaying the obstacle 26, 27 to a vehicle occupant.

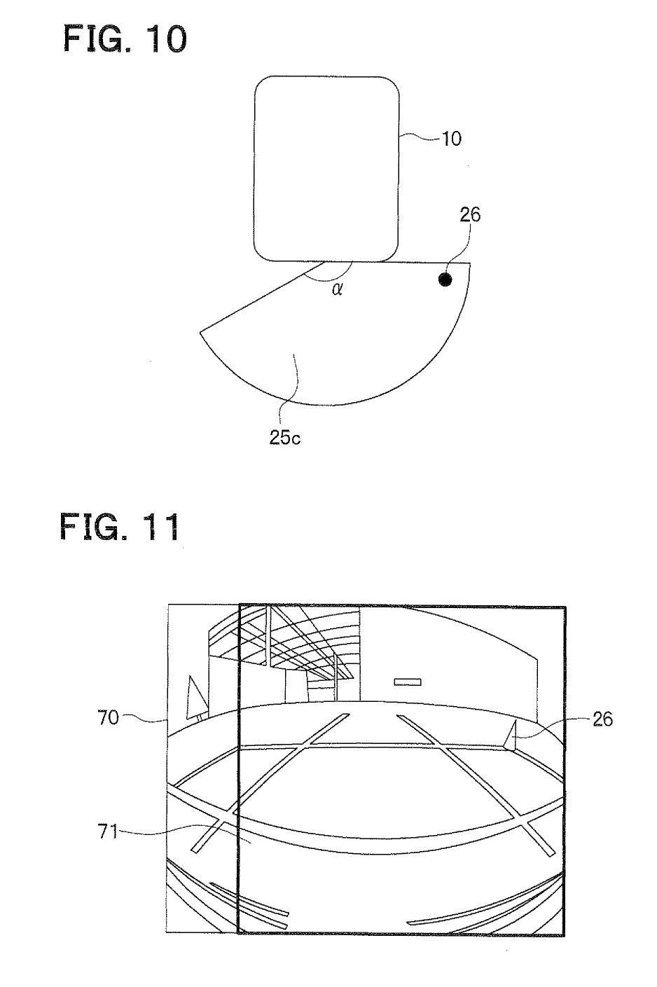

When the third display mode “3” is indicated by the display control parameter, the camera ECU 5b uses a third extraction method. More specifically, the camera ECU 5b sets a display target range 25c as a target range for display, as shown in FIG. 10. The display target range 25c covers the utmost right side part of the photographing range 20 and has an angular width “alpha”. From the camera image, the camera ECU 5b extracts a part corresponding to the display target range 25c. The display target range 25c is an example of a second region.

As described above, in the third display mode “3”, the right end obstacle sensor 1 is detecting an obstacle while the left end obstacle sensor 4 is not detecting an obstacle. The detection range 21 of the right end obstacle sensor 1 covers a region that is rightward away from the display target range 25a for use in the first display mode “1”. Thus, the third display mode “3” involves a possibility that the location of an obstacle 26 detected by the right end obstacle sensor 1 is away from the display target range 25a in a rightward direction, which is an example of the first direction. In the above case, the adoption of the display target range 25c, which covers a region that is rightward away from the normally used display target range 25a, increases a possibility of successfully displaying the obstacle 26 to a vehicle occupant.

Further, since the angle “alpha” is smaller than the angle of view of the photographing range 20, the display target range 25c for use in the third display mode “3” is smaller than the display target range 25b for use in the second display mode “2”. Therefore, in the third display mode “3”, it becomes possible to enlarge the displayed size of a region around the obstacle 26 on a screen of the display device 7, compared to the displayed size of the region in the second display mode “2”.

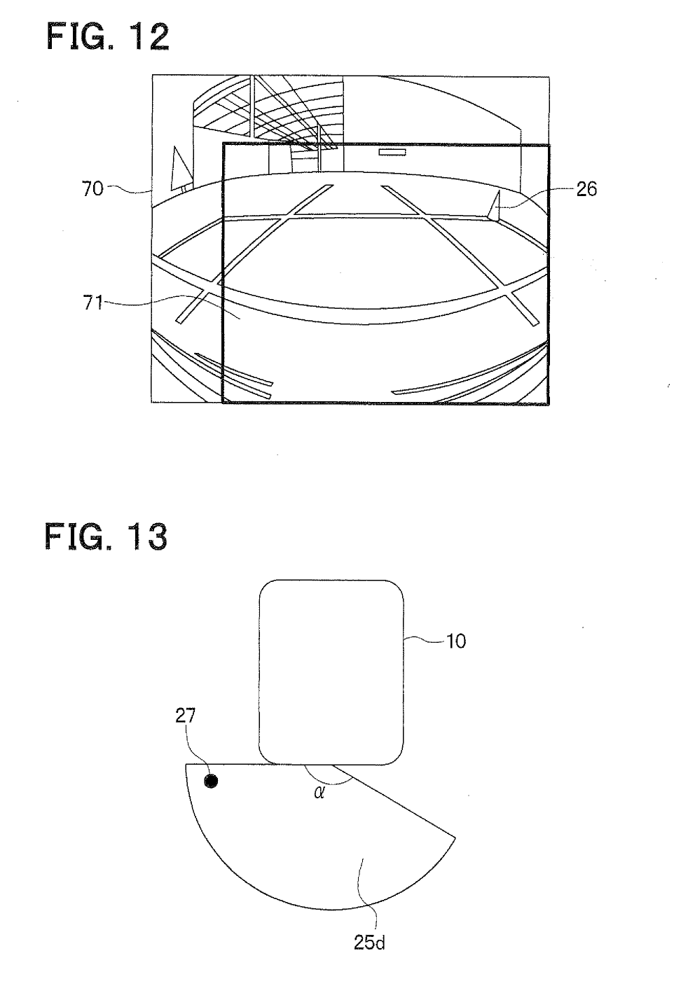

From the camera image, the camera ECU 5b extracts a part corresponding to the display target range 25c. In the third display mode “3”, the part corresponding to the display target range 25c may be, for example, a part 71 surrounded by the solid line in FIG. 11 or, a part 71 surrounded by the solid line in FIG. 12 when the camera image 70 illustrated in FIG. 2 is used.

The part 71 illustrated in FIG. 11 is the camera image 70 whose left-side part is cutout. An aspect ratio of the display part 71 illustrated in FIG. 11 is different from that of the camera image 70. The display part 71 illustrated in FIG. 12 is the camera image 70 whose upper-side part and left-side part are cutout. An aspect ratio of the display part 71 illustrated in FIG. 11 is substantially the same of that of the camera image 70.

When the fourth display mode “4” is indicated by the display control parameter, the camera ECU 5b uses a fourth extraction method. More specifically, the camera ECU 5b sets a display target range 25d as a target range for display, as shown in FIG. 13. The display target range 25d covers the utmost left side part of the photographing range 20 and has an angular width “alpha”. From the camera image, the camera ECU 5b extracts a part corresponding to the display target range 25d. The display target range 25d is an example of the second region.

As described above, in the fourth display mode “4”, the right end obstacle sensor 1 is not detecting an obstacle while the left end obstacle sensor 4 is detecting an obstacle. The detection range 24 of the left end obstacle sensor 4 covers a region that is leftward away from the display target range 25a for use in the first display mode “1”. Thus, the fourth display mode “4” involves a possibility that the location of an obstacle 27 detected by the left end obstacle sensor 4 is away from the display target range 25a in a leftward direction, which is an example of the first direction. In the above case, the adoption of the display target range 25d, which covers a region that is leftward away from the display target range 25a, increases an possibility of successfully displaying the obstacle 27 to a vehicle occupant.

Further, since the angle “alpha” is smaller than the angle of view of the photographing range 20, the display target range 25d for use in the fourth display mode “4” is smaller than the display target range 25b for use in the second display mode “2”. Therefore, in the fourth display mode “4”, it becomes possible to enlarge the displayed size of a region around the obstacle 27 on a screen of the display device 7, compared to the displayed size of the region in the second display mode “2”.

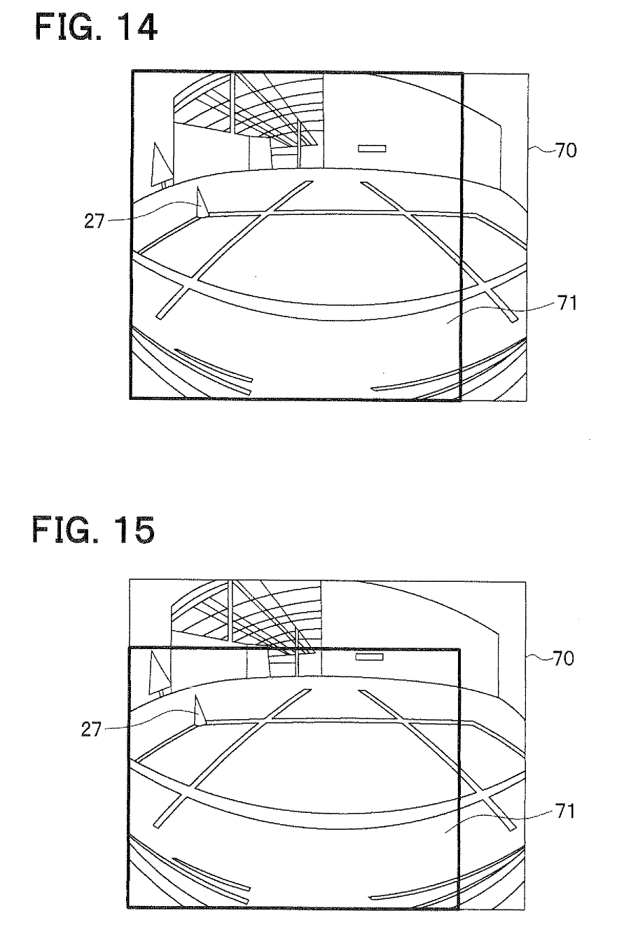

From the camera image, the camera ECU 5b extracts a part corresponding to the display target range 25c. In the fourth display mode “4”, the part corresponding to the display target range 25d may be, for example, a part 71 surrounded by the solid line in FIG. 14 or, a part 71 surrounded by the solid line in FIG. 15 when the camera image 70 illustrated in FIG. 2 is used.

The part 71 illustrated in FIG. 14 is the camera image 70 whose right-side part is cutout. An aspect ratio of the part 71 illustrated in FIG. 14 is different from that of the camera image 70. The part 71 illustrated in FIG. 15 is the camera image 70 whose upper-side part and right-side part are cutout. An aspect ratio of the display part 71 illustrated in FIG. 15 is substantially the same of that of the camera image 70.

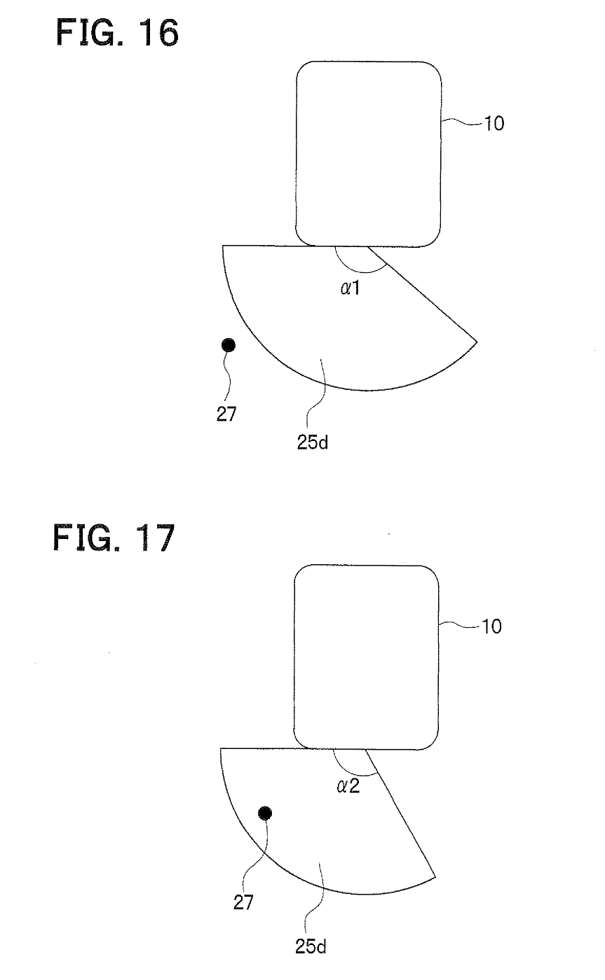

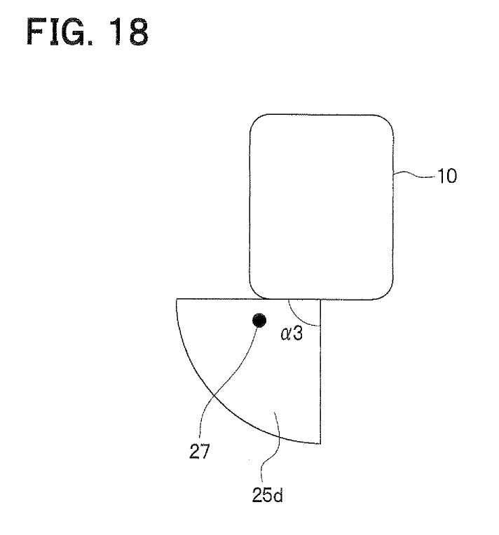

In the third display mode “3” and the fourth display mode “4”, an angle “α” indicative of an angular extent of the display target range with respect to the camera 5a is set to the cutout angle “α” specified in the display control parameter, which is acquired at S220. As illustrated in FIGS. 16 to 18, in the fourth display mode “4”, as a distance between an obstacle and the obstacle sensor detecting the obstacle is smaller, as the target range for display is smaller. For example, as the distance is smaller, the angle “α” is set to an angle “α” of 150 degrees, an angle “α2” of 120 degrees, and an angle of “α3” of 90 degrees.

Based on the above manners, the target range for display is made smaller as an obstacle comes closer to the vehicle. Thus, it becomes possible to relatively enlarge the displayed size of a region around an obstacle on a screen of the display device 7, the region being desired to be displayed to a vehicle occupant. Since an obstacle closer to the vehicle may typically be a matter of higher urgency, the present embodiment displays a larger image of such a higher urgency obstacle to a vehicle occupant.

At S240, if necessary, the camera ECU 5b further performs a process of resizing the part that is extracted from the camera image in a manner according to the above extraction method. For example, the extracted part may be enlarged or reduced so that the number of vertical pixels and horizontal pixels of the resized part matches the predetermined base number of pixels.

As an exemplary case, it is assumed that the predetermined base number of pixels is the vertical pixels “M” and the horizontal pixels “N”, and it is assumed that the extracted part has the vertical pixels “m” and the horizontal pixels “n”. In this case, the camera ECU 5b resizes the horizontal direction of the extracted part to change the number of horizontal pixels by a factor of M/m. Similarly, the camera ECU 5b resizes the vertical direction of the extracted part to change the number of vertical pixels by a factor of N/n. The camera ECU 5b may perform of resizing by utilizing a known technique.

The predetermined base number of pixels may have any value. For example, the predetermined base number of pixels may be set to the number of pixels of the part that is extracted in the second display mode “2”. In such a case, the extracted part in the second display mode may not be resized at S240.

At S250, a display image, which is the image extracted and processed at S240, is outputted to the display device 7. When the display image is outputted to the display device 7 after the number of vertical pixels and horizontal pixels of the extracted display image is changed into the predetermined base number of pixels, the size of the display image on the screen of the display device is constant, regardless of the display mode and the angle “α” in the camera ECU 5b. Therefore, as the target range for display becomes smaller an object in the display image becomes larger.

Because of the above operation, the sonar ECU 6 causes the camera ECU 5b to operate in the first display mode “1” when the both of the right end obstacle sensor 1 and the left end obstacle sensor 4 are not detecting an obstacle. When there arises a possibility that an obstacle exists in a region that is not displayed on a screen of the display device 7 in the first display mode “1”, the sonar ECU 6 causes the camera ECU 5b to operate in one of the second, third and fourth displayed mode “2”, “3”, “4” to set the target range for display to a region covering the region where the obstacle exists. Thereby, the sonar ECU 6 causes the display device 7 to display the obstacle in the region.

Through the above ways, it becomes possible to display a region to which a vehicle occupant, in particular a driver, should pay attention. Since, it is possible to display not only an image corresponding to the maximum photographing range of the camera but also an image corresponding to a part of the photographing range, it is possible to minimize a possibility of downsizing an image part that is desired to be displayed to a vehicle occupant. In other words, it is possible to display an image of the noticeable region to a vehicle occupant in an easily-viewable manner.

In the third or fourth display mode “3”, “4”, when a distance to an obstacle detected by the right or the left end obstacle sensor 1, 4 is smaller, the sonar ECU 6 changes the display target range 25c or 25d into a smaller spatial range by changing the cutout angle “α” into a smaller value.

Through the above manners, as an obstacle comes closer to the vehicle, the display image displayed by the display device 7 represents a smaller area. A part of the display image, the part corresponding to the location of the obstacle and the area to be displayed to a vehicle occupant, becomes relatively larger, since the size of the display image on the screen of the display device 7 is constant. Although an obstacle closer to the vehicle may typically be a matter of higher urgency, it is possible display a larger image of such an obstacle of higher urgency to a vehicle occupant.

The above embodiments can be modified in various ways.

For example, a sensor for detecting a location of an obstacle existing around the vehicle is not limited to sonar. Any device capable of detecting the presence of and the distance to an obstacle in a predetermined range can be used. For example, a laser radar sensor, a millimeter-wave sensor or the like can be used.

In the above embodiments and its modifications, the sonar ECU 6 acts as an example of an image displaying control in-vehicle apparatus for performing control in the image displaying in-vehicle system. More specifically, the sonar ECU 6 performing a step S100 exemplified in FIG. 3 acts as an example of an acquisition section or means that acquires obstacle information from a sensor (e.g., obstacle sensor), the obstacle information including information on whether the sensor detects a presence of an obstacle, the obstacle information further including information on a location of the obstacle when the sensor detects the presence of the obstacle. The sonar ECU performing steps S120 to S140 exemplified in FIG. 3 acts as an example of a display control section or means that: (i) causes the display device to display a first display image showing a first region of an outside of the vehicle based on a camera image when the obstacle information indicates that the sensor detects an absence of the obstacle, the first region covering a center of a photographing range of the camera; and (ii) causes the display device to display a second display image showing a second region of the outside of the vehicle based on the camera image when the obstacle information indicates that the obstacle sensor detects the presence of the obstacle and when the obstacle information further indicates that the location of the obstacle is away from the first region in a first direction, the second region being a part of the photographing range of the camera, the second region covering a place that is away from the first region in the first direction. When the obstacle information indicates that the obstacle sensor detects the presence of the obstacle and when the obstacle information further indicates that the location of the obstacle is away from the first region in the first direction, the display control section or means may cause the display device to display the second display image based on the camera image in such manner that, as a distance to the obstacle is smaller, the second region has a smaller spatial range.

While the invention has been described above with reference to various embodiments thereof, it is to be understood that the invention is not limited to the above described embodiments and constructions. The invention is intended to cover various modifications and equivalent arrangements. In addition, while the various combinations and configurations described above are contemplated as embodying the invention, other combinations and configurations, including more, less or only a single element, are also contemplated as being within the scope of embodiments.

Further, each or any combination of processes, steps, or means explained in the above can be achieved as a software section or unit (e.g., subroutine) and/or a hardware section or unit (e.g., circuit or integrated circuit), including or not including a function of a related device, furthermore, the hardware section or unit can be constructed inside of a microcomputer.

Furthermore, the software section or unit or any combinations of multiple software sections or units can be included in a software program, which can be contained in a computer-readable storage media or can be downloaded and installed in a computer via a communications network.

What is claimed is:

1. An image displaying control in-vehicle apparatus for a vehicle equipped with (i) a sensor for detecting an obstacle existing around the vehicle, (ii) a camera for capturing a camera image of an outside of the vehicle, and (iii) a display device, the image displaying control in-vehicle apparatus comprising:
an acquisition section that is configured to acquire obstacle information from the sensor, the obstacle information including information on whether the sensor detects a presence of the obstacle, the obstacle information further including information on a location of the obstacle when the sensor detects the presence of the obstacle; and
a display control section that is configured to:
cause the display device to display a first display image showing a first region of the outside of the vehicle based on the camera image when the obstacle information indicates that the sensor detects an absence of the obstacle, the first region covering a center of a photographing range of the camera; and
causes the display device to display a second display image showing a second region of the outside of the vehicle based on the camera image when the obstacle information indicates that the sensor detects the presence of the obstacle and when the obstacle information further indicates that the location of the obstacle is away from the first region in a first direction, the second region being a part of the photographing range of the camera, the second region covering a place that is away from the first region in the first direction.

2. The image displaying control in-vehicle apparatus according to claim 1, wherein:
when the obstacle information indicates that the sensor detects the presence of the obstacle and when the obstacle information further indicates that the location of the obstacle is away from the first region in the first direction,
the display control section is configured to cause the display device to display the second display image based on the camera image in such manner that, as a distance to the obstacle is smaller, the second region has a smaller spatial range.

3. An image displaying in-vehicle system for a vehicle equipped with a sensor for detecting an obstacle existing around the vehicle, the image displaying in-vehicle system comprising:
a camera mounted to the vehicle and configured to capture a camera image of an outside of the vehicle;
a display device; and
an image displaying control in-vehicle apparatus coupled with the camera and the display device, the image displaying control in-vehicle apparatus including
an acquisition section that is configured to acquire obstacle information from the sensor, the obstacle information including information on whether the sensor detects a presence of the obstacle, the obstacle information further including information on a location of the obstacle when the sensor detects the presence of the obstacle; and
a display control section that is configured to:
cause the display device to display a first display image showing a first region of the outside of the vehicle based on the camera image when the obstacle information indicates that the sensor detects an absence of the obstacle, the first region covering a center of a photographing range of the camera; and
causes the display device to display a second display image showing a second region of the outside of the vehicle based on the camera image when the obstacle information indicates that the sensor detects the presence of the obstacle and when the obstacle information further indicates that the location of the obstacle is away from the first region in a first direction, the second region being a part of the photographing range of the camera, the second region covering a place that is away from the first region in the first direction.

4. A computer readable medium comprising instructions to cause an image displaying control in-vehicle apparatus, which is for use in a vehicle equipped with (i) a sensor for detecting an obstacle existing around the vehicle, (ii) a camera for capturing a camera image of an outside of the vehicle, and (iii) a display device, to execute steps of:
acquiring obstacle information from the sensor, the obstacle information including information on whether the sensor detects a presence of the obstacle, the obstacle information further including information on a location of the obstacle when the sensor detects the presence of the obstacle; and
causing the display device to display a first display image showing a first region of the outside of the vehicle based on the camera image when the obstacle information indicates that the sensor detects an absence of the obstacle, the first region covering a center of a photographing range of the camera; and
causing the display device to display a second display image showing a second region of the outside of the vehicle based on the camera image when the obstacle information indicates that the sensor detects the presence of the obstacle and when the obstacle information further indicates that the location of the obstacle is away from the first region in a first direction, the second region being a part of the photographing range of the camera, the second region covering a place that is away from the first region in the first direction.
